(19) United States
(12) Patent Application Publication
(10) Pub. No.: US 2007/0030303 A1
(43) Pub. Date: Feb. 8, 2007

(54) Inkjet image forming apparatus

(75) Inventors: Dong-woo Ha, Suwon-si (KR); Jin-ho Park, Yongin-si (KR); Sung-wook Kang, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/491,925

(22) Filed: Jul. 25, 2006

(30) Foreign Application Priority Data
Aug. 5, 2005 (KR) 2005-71694

(51) Int. Cl. B41J 2/165

(52) U.S. Cl. 347/33

(57) ABSTRACT

An image forming apparatus includes an inkjet head having a length corresponding to a width of a printing medium and a nozzle unit formed with a plurality of nozzles, a platen installed under the inkjet head to support the printing medium, a wiping roller to wipe the nozzle unit, and a carriage unit to cause the wiping roller to make contact with the nozzle unit to absorb ink while the carriage unit rotates the platen and the carriage unit places the wiping roller wiping the nozzle unit apart from the nozzle unit while the carriage unit returns the platen to an original position.

### CROSS-REFERENCE TO RELATED APPLICATIONS

This application claims the benefit of Korean Patent Application No. 10-2005-0071694, filed on Aug. 5, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus that is provided with a wiping device to remove remaining ink from a nozzle unit.

2. Description of the Related Art

Generally, an inkjet image forming apparatus is a device that forms an image by ejecting ink onto a printing medium from an inkjet head (a shuttle type inkjet head) that is spaced apart from a top surface of the printing medium and moved in a perpendicular direction to a feeding direction of the printing medium (a width direction of the printing medium). The inkjet head includes a nozzle unit having a plurality of nozzles to eject ink.

Recently, instead of the shuttle type inkjet head that is moved in the width direction of the printing medium, a line printing type inkjet head that has a nozzle unit having a length corresponding to the width of the printing medium has been developed to achieve a high speed printing. In an image forming apparatus with the line printing type inkjet head, the inkjet head is fixed and only the printing medium is moved, thereby simplifying the driving unit of the image forming apparatus and achieving a high speed printing.

When ink is ejected from the nozzle unit onto the printing medium, an ejecting direction of the ink is distorted and thus the image quality is lowered due to materials attached to the nozzle unit, such as droplets of ink that remain and are not ejected, solid material that remain after the unejected droplets of ink are dried, and foreign substances such as micro dust absorbed from the surrounding air. Therefore, a wiping device is required to remove the materials from the nozzle unit to keep the image quality high.

Specifically, the nozzle unit of the line printing type inkjet head has, for example, a length of about 210 mm corresponding to the width of an A4 size printing medium when the width margin of a page is not considered. Therefore, the line printing type inkjet head requires a wiping device that can effectively remove the remaining ink and foreign substances from the nozzle unit of the line printing type inkjet head.

Further, a platen is installed under the line printing type inkjet head to support the feeding of the printing medium. The platen, which supports the printing medium during printing, must not disturb the operation of the wiping device after the printing. Therefore, it is required to install the platen and the wiping device without interference therebetween during their operations.

### SUMMARY OF THE INVENTION

The present general inventive concept provides an inkjet image forming apparatus that is provided with a wiping device to effectively remove foreign substances from a nozzle unit of an inkjet head to maintain a high quality image printing.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including an inkjet head having a length corresponding to a width of a printing medium and a nozzle unit formed with a plurality of nozzles, a platen installed under the inkjet head to support the printing medium, a wiping roller to wipe the nozzle unit, and a carriage unit to move the wiping roller to make contact with the nozzle unit to absorb ink while the carriage unit rotates the platen from an original position, to move the wiping roller to wipe the nozzle unit, and to move the wiping roller away apart from the nozzle unit while the carriage unit returns the platen to the original position.

The foregoing and/or other aspects and utilities of the present general inventive concept may also be achieved by providing an image forming apparatus, including an inkjet head having a nozzle unit, a wiping roller to absorb ink from the nozzle unit when the wiping roller moves in a first direction across a surface thereof and to wipe ink from the surface of the nozzle unit when the wiping roller moves in a second direction across the surface of the nozzle unit, and a support unit to support the wiping roller and to allow the wiping roller when moving in the first direction and to prevent the wiping roller from rotating when moving in the second direction.

The foregoing and/or other aspects and utilities of the present general inventive concept may also be achieved by providing an image forming apparatus, including an inkjet printhead having a nozzle unit with a plurality of nozzles, a platen moveably disposed adjacent to the printhead to support a printing medium to be printed on by the nozzle unit, the platen movable to a first position away from the nozzle unit when the nozzle unit is being cleaned and moveable to a second position adjacent to the nozzle unit to support the printing medium to be printed on by the nozzle unit, and a carriage unit to support the platen to move between the first and second positions.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a partial side view illustrating an inkjet image forming apparatus according to an embodiment of the present general inventive concept;

FIG. 2 is a partial perspective view illustrating a relationship between a platen, a wiping roller, and a carriage unit of FIG. 1;

FIG. 3 is a side view illustrating an absorption of ink by the wiping roller of FIG. 1;

FIG. 4 is a partial side view illustrating a supporting hole during the absorption of the ink by the wiping roller of FIG. 1;

FIG. 5 is a partial side view illustrating a stopper during the absorption of the ink by the wiping roller of FIG. 1;

FIG. 6 is a partial perspective view illustrating a positioning of the wiping roller and the carriage unit after the absorption of remaining ink by the wiping roller of FIG. 1;

FIG. 7 is a partial side view illustrating a relationship between the platen, the wiping roller, and the carriage unit of FIG. 6;

FIG. 8 is a side view illustrating a wiping action of the wiping roller of FIG. 1;

FIG. 9 is a partial side view illustrating a supporting hole during the wiping of the ink by the wiping roller of FIG. 1; and

FIG. 10 is a partial side view illustrating a stopper during the wiping of the ink by the wiping roller of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

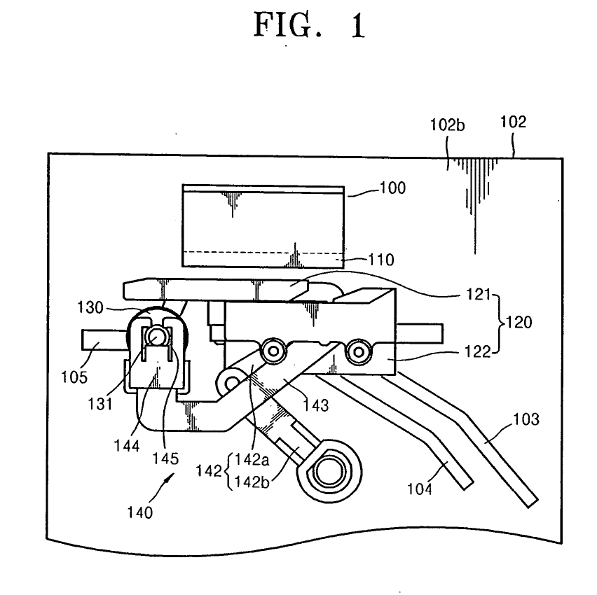

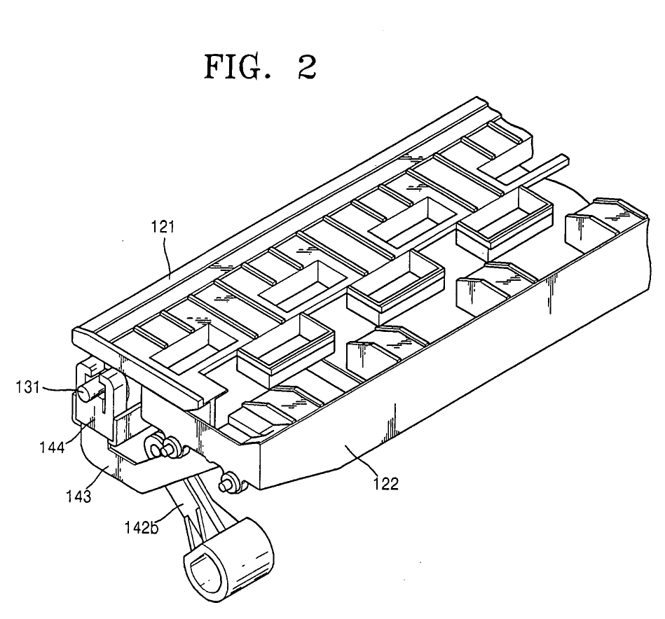

FIG. 1 is a partial side view illustrating an inkjet image forming apparatus according to an embodiment of the present general inventive concept. FIG. 2 is a partial perspective view illustrating a relationship between a platen, a wiping roller, and a carriage unit of FIG. 1. Referring to FIGS. 1 and 2, an inkjet image forming apparatus includes an inkjet head 100, a platen 120, a wiping roller 130, and a carriage unit 140.

The inkjet head 100 is a line array head that has a length corresponding to a width of a printing medium. A nozzle unit 110 having a plurality of nozzles (not shown) to eject ink is provided on a bottom surface of the inkjet head 100.

The platen 120 is spaced apart from the bottom surface of the inkjet head 100 to support the printing medium as the printing medium passes under the inkjet head 100. The platen 120 includes a first platen 121 and a second platen 122 that are capable of spreading and overlapping motions. When the platen 120 supports the printing medium, the first and second platens 121 and 122 are spread apart from each other to stably support the printing medium with a wider area. As illustrated in FIG. 1, when the first and second platens 121 and 122 are spread apart, a portion of the first and second platens 121 and 122 continue to overlap each other. When the wiping roller 130 absorbs and wipes the ink from the nozzle unit 110, the first and second platens 121 and 122 move to overlap each other to take less space by reducing their area.

After ejection of ink from the nozzle unit 110, the wiping roller 130 makes contact with the nozzle unit 110 to remove remaining ink from the nozzle unit 110 by absorbing and wiping the remaining ink from the nozzle unit 110. The wiping roller 130 may be formed of a material that is suitable to absorb and wipe the remaining ink.

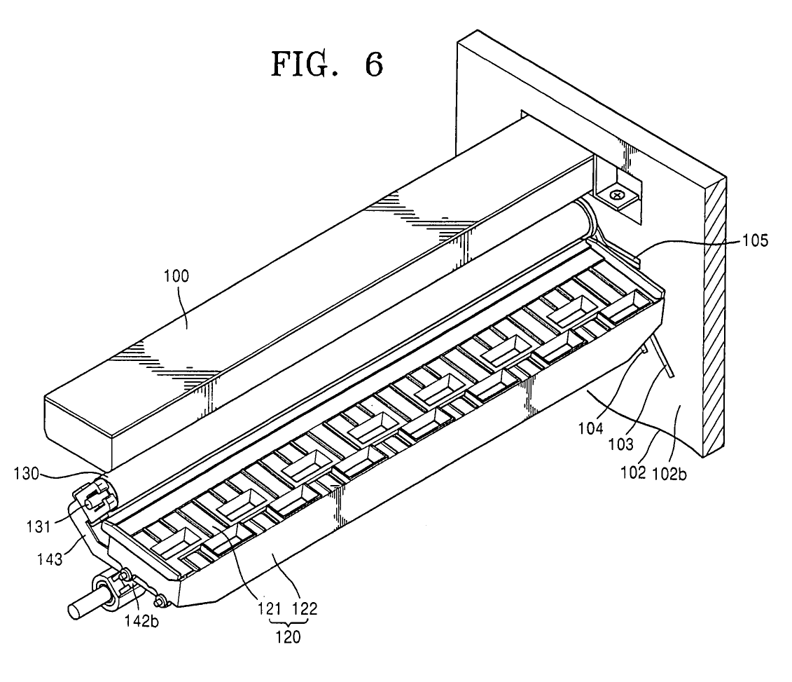

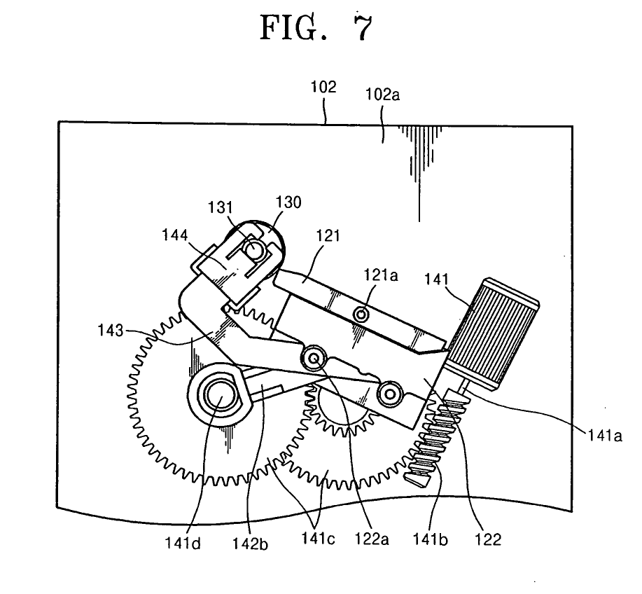

FIG. 6 is a partial perspective view illustrating the inkjet image forming apparatus after the absorption of the remaining ink by the wiping roller 130. FIG. 7 is a partial side view illustrating a relationship between the platen 120, the wiping roller 130, and the carriage unit 140 of the inkjet image forming apparatus of FIG. 6. Referring to FIGS. 6 and 7, the carriage unit 140 moves the platen 120 and the wiping roller 130 to cause the wiping roller 130 to contact the nozzle unit 110 to absorb and wipe the remaining ink therefrom. The carriage unit 140 includes a motor 141, a link 142, and a bracket 143. The motor 141 is installed on a first side 102a of main frame 102 and can rotate in both forward and reverse directions. A driving force of the motor 141 is transmitted to the link 142 through a shaft 141a, a worm gear 141b formed on an end of the shaft 141a, and connection gears 141c in contact with the worm gear 141b.

The link 142 has one end connected to a shaft 141 d of the connection gear 141c and a second end pivotably connected to the first platen 121. Further, the link 142 has a joint structure such that the link 142 can be folded and unfolded. That is, as illustrated in FIG. 1, the link 142 may have a first link part 142a and a second link part 142b. One end of the first link part 142a can be rotatably connected to the first platen 121. One end of the second link part 142b can be rotatably connected to the shaft 141d. A second end of the first link part 142a and a second end of the second link part 142b are rotatably connected to each other as the shaft 141d rotates to fold and unfold the link 142 (including the first and second link parts 142a and 142b).

The bracket 143 has a first end pivotably connected to the second platen 122 and a second end provided with a support 144 to rotatably support the wiping roller 130.

The support 144 includes a supporting hole 145 (see FIG. 1) formed therein in which a shaft 131 of the wiping roller 130 can move in left and right directions. Therefore, as the shaft 131 moves in the left and right directions within the supporting hole 145, the shaft 131 can also be rotated in the supporting hole 145.

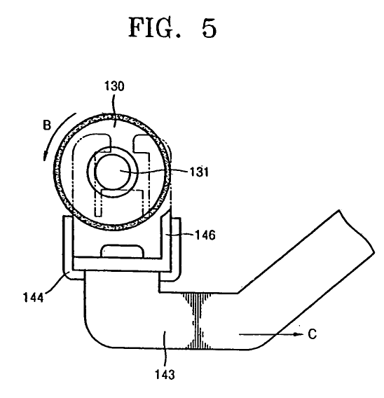

The support 144, as illustrated in FIG. 5, is provided with a stopper 146 that extends from the support 144 toward the wiping roller 130 along the length direction of the wiping roller 130. When the stopper 146 makes contact with the wiping roller 130, the stopper 146 restricts the rotation of the wiping roller 130. The operation of the stopper 146 will be more fully described later.

A second side 102b of the main frame 102, opposite to the first side 102a of the main frame 102, defines a first guide groove 103, a second guide groove 104, and a third guide groove 105 that have different shapes.

The first guide groove 103 guides a first guide protrusion 121a formed on one side of the first platen 121, and the second guide groove 104 guides a second guide protrusion 122a formed on one side of the second platen 122. The first and second guide protrusions 121a and 122a are slidably inserted in the first and second guide grooves 103 and 104, respectively. The third guide groove 105 guides the shaft 131 of the wiping roller 130. One end of the shaft 131 is slidably inserted in the third guide groove 105.

Therefore, since the first platen 121, the second platen 122, and the wiping roller 130 are slidably inserted in the first guide groove 103, the second guide groove 104, and the third guide groove 105, respectively, the first platen 121, the second platen 122, and the wiping roller 130 can each be moved by desired distances in desired directions.

The first side 102a of the main frame 102 and the second side 102b of the main frame 102 face each other. The first link part 142a and the bracket 143 may be provided on both sides of the first platen 121 and the second platen 122, respectively. Particularly, the shaft 141d may be provided along a length direction of the platen 120 to connect with the second link part 142b provided on both sides of the platen 120.

The wiping roller 130 is provided to absorb and wipe ink remaining on a surface of the nozzle unit 110. The absorption and wiping operations of the wiping roller 130 will now be described with reference to the accompanying drawings. Since the absorption and the wiping operations are sequentially carried out, descriptions thereof will be made in sequence.

First, the absorption operation of the wiping roller 130 will be described.

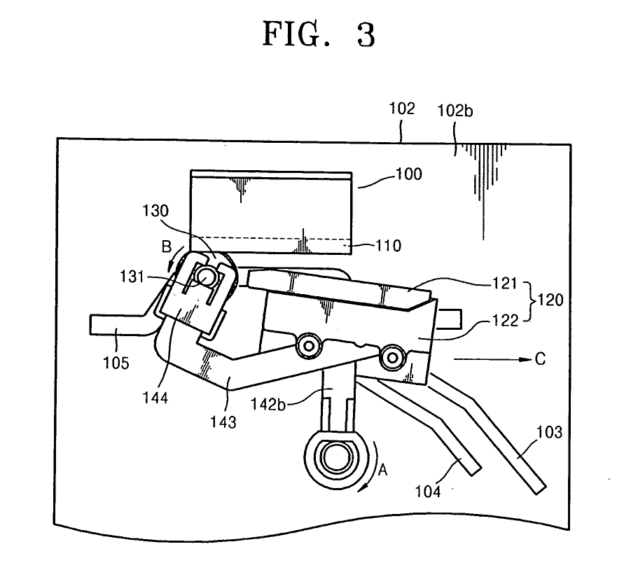

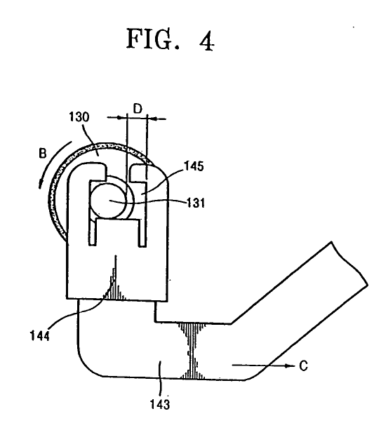

FIG. 3 is a side view illustrating the absorption of the remaining ink by the wiping roller 130. FIGS. 4 and 5 are partial side views illustrating the supporting hole 145 during the absorption of the remaining ink by the wiping roller 130. Referring to FIGS. 3 through 5, when the motor 141 (illustrated in FIG. 7) rotates in a forward direction (clockwise), the shaft 141d connected to motor 141 through the connection gears 141c is rotated in a clockwise direction illustrated by arrow A. The first link part 142a, as the second link part 142b rotates clockwise about the shaft 141d, moves the first platen 121 in a direction illustrated by arrow C. The first platen 121, as it is moved in the direction of arrow C, overlaps with the second platen 122. The second link part 142b further rotates in the direction of arrow A after the first and second platens 121 and 122 overlap, such that the first and second platens 121 and 122 move together.

As the second platen 122 moves, the bracket 143 connected to the second platen 122 is also moved. As the bracket 143 is moved, the wiping roller 130 provided on one end of the bracket 143 approaches the nozzle unit 110 to make contact with a bottom surface of the nozzle unit 110.

If the second link part 142b further rotates in the direction of arrow A after the wiping roller 130 makes contact with the bottom surface of the nozzle unit 110, the wiping roller 130, while in contact with the bottom surface of the nozzle unit 110, is moved in the direction of arrow C while the wiping roller is rotated in a direction of arrow B.

Since the shaft 131 of the wiping roller 130 is biased to the left in the supporting hole 145, as illustrated in FIG. 4, a right marginal space D is created. Therefore, as illustrated in FIG. 5, the stopper 146 does not make contact with the wiping roller 130. When the wiping roller 130 is not in contact with the stopper 146, the wiping roller 130 can rotate. Thus, while the wiping roller 130 rotates, the wiping roller 130 can absorb the remaining ink from the bottom surface of the nozzle unit 110. The wiping roller 130 rotates in the direction of arrow B as the wiping roller 130 is in contact with and moves across the bottom surface of the nozzle unit 110.

Referring to FIGS. 6 and 7, when the wiping roller 130 finishes the absorption of the remaining ink, the wiping roller 130 reaches a right end of the inkjet head 100, and the platen 120 completely moves away from the bottom surface of the nozzle unit 110 to a side of the nozzle unit 110.

Next, the wiping operation of the wiping roller 130 will be described.

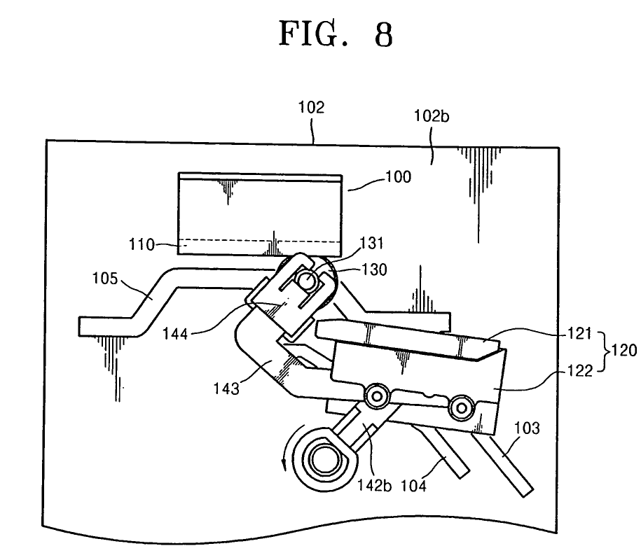

FIGS. 8-10 are views illustrating the wiping operation of the wiping roller 130. Referring to FIGS. 8 through 10, when the motor 141 rotates in a reverse direction (the counterclockwise direction), the second link part 142b is rotated counterclockwise about the shaft 141d. Therefore, the first and second platens 121 and 122 that are overlapped move in a direction opposite to the absorption direction of the wiping roller 130.

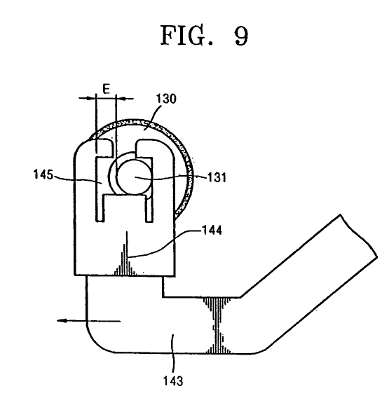

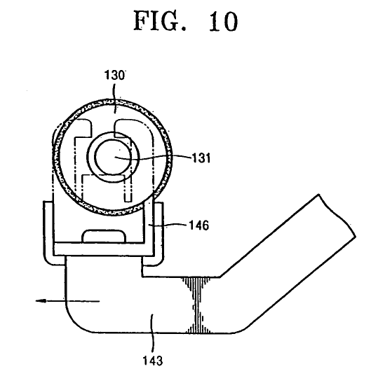

Since the wiping roller 130 is in contact with the nozzle unit 110, the shaft 131 of the wiping roller 130, as illustrated in FIG. 9, becomes biased to the right in the supporting hole 145 to be spaced apart from the left of the supporting hole 145 by a gap E upon the movement of the first and second platens 121 and 122. Therefore, the stopper 146, as illustrated in FIG. 10, makes contact with the wiping roller 130 to restrict the rotation of the wiping roller 130.

Owing to above-described structure, when the wiping roller 130 is in contact with the stopper 146, the wiping roller 130 moves across the bottom surface of the nozzle unit 110 without rotating. As the wiping roller 130 moves across the bottom of the nozzle unit 130 without rotating, the wiping roller wipes the nozzle unit 110. The stopper 146 may be made of a material to frictionally prevent the wiping roller 130 from rotating. That is, a frictional force between the stopper 146 and the wiping roller 130 is greater than a frictional force between the wiping roller 130 and the nozzle unit 110.

The first and second guide grooves 103 and 104 may have different lengths, such that, though the first and second platens 121 and 122 are moved together initially, the first platen 121 can be further moved after the second platen 122 is stopped at an end of the second guide groove 104. Therefore, the first and second platens 121 and 122 can be spread apart from each other to return to the state illustrated in FIGS. 1 and 2.

As described above, the image forming apparatus of the present general inventive concept includes a wiping roller to absorb ink remaining on a nozzle unit while rotating and to wipe the nozzle unit while in contact with the nozzle unit. Therefore, the image quality of the image forming apparatus can be improved due to the cleaning operation of the nozzle unit by a wiping roller.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
an inkjet head having a length corresponding to a width of a printing medium and a nozzle unit formed with a plurality of nozzles;
a platen installed under the inkjet head to support the printing medium;
a wiping roller to wipe the nozzle unit; and
a carriage unit to move the wiping roller to make contact with the nozzle unit to absorb ink while the carriage unit rotates the platen from an original position, to move the wiping roller to wipe the nozzle unit, and to move the wiping roller away from the nozzle unit while the carriage unit returns the platen to the original position.

2. The image forming apparatus of claim 1, wherein the platen comprises a first platen and a second platen that spread apart and overlap with respect to each other, the first platen and the second platen being arranged sequentially along a feeding direction of the printing medium.

3. The image forming apparatus of claim 2, wherein the carriage unit comprises:
a motor to rotate in a forward direction or in a reverse direction;
a link rotatably connected to the first platen to transmit a driving force of the motor thereto; and
a bracket having a first end rotatably connected to the second platen and the second end provided with a support to rotatably support the wiping roller.

4. The image forming apparatus of claim 3, wherein the support defines a supporting hole to support a shaft of the wiping roller, the supporting hole shaped to allow the shaft of the wiping roller to move in left and right directions in the supporting hole.

5. The image forming apparatus of claim 3, further comprising:
a stopper that extends from the support toward the wiping roller along a length direction of the wiping roller, the stopper being spaced apart from the wiping roller when the motor rotates in the forward direction and being in contact with the wiping roller when the motor rotates in the reverse direction.

6. The image forming apparatus of claim 5, wherein frictional force between the stopper and the wiping roller is larger than frictional force between the wiping roller and the inkjet head.

7. The image forming apparatus of claim 2, wherein the first and second platens slide while being respectively guided by guide grooves formed on a main frame of the image forming apparatus.

8. The image forming apparatus of claim 7, wherein the first and second platens move along the guide grooves to spread apart from each other when a motor of the carriage unit rotates in a reverse direction.

9. The image forming apparatus of claim 2, wherein the wiping roller has a shaft that slides while being guided by a guide groove formed on a main frame of the image forming apparatus.

10. The image forming apparatus of 2, wherein:
the carriage unit includes a motor and a link rotatably connected to the first platen to transmit a driving force of the motor thereto, and
when the motor rotates in a forward direction, the first platen is rotated by the link in the feeding direction of the printing medium to join with the second platen and to be rotated with the second platen.

11. The image forming apparatus of claim 10, wherein the link comprises a first link part connected to the first platen and a second link part connected to a gear to transmit the driving force of the motor, the first and second link parts rotate with respect to each other as the motor rotates.

12. An image forming apparatus, comprising:
an inkjet head including a nozzle unit;
a wiping roller to absorb ink from the nozzle unit when the wiping roller moves in a first direction across a surface thereof and to wipe ink from the surface of the nozzle unit when the wiping roller moves in a second direction across the surface of the nozzle unit; and
a support unit to support the wiping roller and to allow the wiping roller when moving in the first direction and to prevent the wiping roller from rotating when moving in the second direction.

13. The image forming apparatus of claim 12, further comprising:
a platen unit provided under the nozzle unit to support a printing medium.

14. The image forming apparatus of claim 13, wherein the platen unit comprises:
a first platen unit and a second platen unit moveable with respect to each other between a spread apart position and an overlap position such that the first platen unit overlaps the second platen unit when the wiping roller moves in the first direction and is spread apart from the second platen when the wiping roller moves in the second direction.

15. The image forming apparatus of claim 14, further comprising a carriage unit connected to the first platen unit to move the first platen unit from the spread apart position to the overlap position with respect to the second platen unit.

16. The image forming apparatus of claim 15, wherein the second platen unit is connected to the support unit such that when the first platen unit overlaps the second platen unit, the second platen unit moves the wiping roller in the first direction.

17. The image forming apparatus of claim 12, wherein the wiping roller contacts a bottom surface of the nozzle unit.

18. The image forming apparatus of claim 12, wherein the support comprises a stopping unit to stop the rotation of the wiping roller when the wiping roller is moved in the second direction.

19. The image forming apparatus of claim 12, wherein the wiping roller comprises a shaft on which to rotate, and the shaft is rotatably supported by the support unit.

20. The image forming apparatus of claim 19, wherein the support unit has at least one support hole formed therein to receive the shaft.

21. The image forming apparatus of claim 19, wherein the support hole defines a marginal space between the shaft and an inner wall of the support hole on a first side of the shaft when the shaft is biased in a first direction within the support hole.

22. The image forming apparatus of claim 19, wherein the support hole defines a gap between the shaft and an inner wall of the support hole on a second side of the shaft when the shaft is biased in a second direction within the support hole.

23. An image forming apparatus, comprising:
an inkjet printhead having a nozzle unit with a plurality of nozzles;
a platen moveably disposed adjacent to the printhead to support a printing medium to be printed on by the nozzle unit, the platen movable to a first position away from the nozzle unit when the nozzle unit is being cleaned and moveable to a second position adjacent to the nozzle unit to support the printing medium to be printed on by the nozzle unit; and
a carriage unit to support the platen to move between the first and second positions.

24. The image forming apparatus of claim 23, further comprising a wiping roller connected to the platen such that the platen moves the wiping roller in a first direction to absorb ink from the nozzles of the nozzle unit when the platen moves to the first position and moves the wiping roller in a second direction to wipe the nozzles of the nozzle unit when the platen moves to the second position.

25. The image forming apparatus of claim 24, wherein the platen comprises a first platen and a second platen moveable with respect to each other between the first position and the second position.

26. The image forming apparatus of claim 25, wherein the first platen overlaps the second platen when the wiping roller moves in the first direction and is spread apart from the second platen when the wiping roller moves in the second direction.

27. The image forming apparatus of claim 25, further comprising a bracket formed on a bottom surface of the second platen connected to the wiping roller to move the wiping roller to the first and second positions.

28. The image forming apparatus of claim 25, wherein:
the first platen has a guide protrusion formed thereon; and
the image forming apparatus further comprises a frame having a first guide groove defined therein to guide the guide protrusion of the first platen as the first platen moves from the first position to the second position.

29. The image forming apparatus of claim 28, wherein:
the second platen has a guide protrusion formed thereon; and
the image forming apparatus further comprises a frame having a second guide groove defined therein to guide the guide protrusion of the second platen as the second platen moves from the first position to the second position.

30. The image forming apparatus of claim 28, wherein:
the wiping roller comprises a shaft to support the wiping roller; and
the image forming apparatus further comprises a frame having a third guide groove defined therein to guide the shaft of the wiping roller as the wiping roller moves in the first and second directions.

31. The image forming apparatus of claim 24, further comprising a support unit to support the wiping roller.

32. The image forming apparatus of claim 31, wherein the support unit comprises a stopper to stop a rotation of the wiping roller when the wiping roller is moved in the second direction.

33. The image forming apparatus of claim 24, wherein the carriage unit moves the wiping roller from contact with the nozzle unit when the platen moves to the second position and the carriage unit moves the wiping roller to contact the nozzles when the platen moves to the first position to clean the nozzles.
